(19) United States
(12) Patent Application Publication
(10) Pub. No.: US 2013/0278880 A1
(43) Pub. Date: Oct. 24, 2013

(54) Method of Manufacturing Liquid Crystal Panel

(71) Applicant: Chih-tsung Kang, Shenzhen (CN)

(72) Inventor: Chih-tsung Kang, Shenzhen (CN)

(73) Assignee: SHENZHEN CHINA STAR OPTOELECTRONICS TECHNOLOGY CO. LTD., Shenzhen, Guangdong (CN)

(21) Appl. No.: 13/583,161

(22) PCT Filed: May 17, 2012
(86) PCT No.: PCT/CN12/75625

§ 371 Date: Sep. 6, 2012

(30) Foreign Application Priority Data
Apr. 19, 2012 (CN) 201210118220.5

(51) Int. Cl. G02F 1/1341

(52) U.S. Cl. 349/189

(57) ABSTRACT

A manufacturing method of a liquid crystal panel includes the following steps: adding polymer monomers to liquid crystals and then injecting the liquid crystals into space between a thin film transistor array substrate and a color filter substrate vacuum bonded to the thin film transistor array substrate to form the liquid crystal panel; exposing the liquid crystal panel to light of a spectrum ranging from 300 nm to 450 nm and of an illuminance ranging from 10 mW/cm² to 30 mW/cm² when the wavelength ranges from 300 nm to 400 nm, and exposing the liquid crystal panel for an exposure time period lasting for 30 to 50 seconds; and curing the exposed liquid crystal panel and simultaneously applying a curing voltage to the liquid crystal panel. The liquid crystal panel manufactured according to the manufacturing method has an improved contrast and liquid crystal response speed.

### BACKGROUND

1. Technical Field

The present disclosure relates to liquid crystal displaying technologies and, particularly, to a manufacturing method of a liquid crystal panel.

2. Description of Related Art

Liquid Crystal Display (LCD) is a Flat Panel Display (FPD) that uses the characteristics of liquid crystal to display image. Compared to other types of display, LCD is thin and it requires lower driving voltage and lower power consumption, which makes it the mainstream product in the consumer goods market.

Liquid crystal panel is the main component of LCD. A liquid crystal panel includes a TFT array substrate, a CF substrate vacuum bonded to the TFT array substrate, and a liquid crystal layer and an alignment film disposed between the TFT array substrate and the CF substrate. The alignment film can be disposed on the TFT array substrate and/or the CF substrate for controlling liquid crystal molecules of the liquid crystal layer to be arranged in predetermined initial states and thus affect displaying property of the liquid crystal panel. Therefore, controlling of the alignment film is very important.

Generally, in a first manufacturing method of the alignment film, alignment liquid is coated on inner surfaces of the TFT array substrate and the CF substrate to form the alignment film when the TFT array substrate and the CF substrate are being manufactured. In a second manufacturing method of the alignment film, liquid crystal molecules and monomers used for polymer alignment are injected into the vacuum bonded liquid crystal panel and are irradiated by light to be cured. In this way, the polymer monomers disposed on inner surfaces of the TFT array substrate and the CF substrate form the alignment film for guiding the liquid crystal molecules to be regularly arranged.

In the first manufacturing method mentioned above, static electricity is easily generated and impurities may be brought by a coating brush when coating the alignment liquid on the substrates, which may damage the liquid crystal panel; in the second manufacturing method mentioned above, although the alignment film is formed in a non-contact way, the polymer monomers are sensitive to light, thus, when the polymer monomers are irradiated by light to form the alignment film in different processes, the optical property, reliability and production capacity of the liquid crystal panel may be influenced.

### SUMMARY

One object of the present disclosure is to provide a manufacturing method of a liquid crystal panel, which is capable of improving the reliability and optical property of the liquid crystal panel manufactured according to the method. The manufacturing method includes the following steps:

adding polymer monomers to liquid crystals and then injecting the liquid crystals into space between a thin film transistor array substrate and a color filter substrate vacuum bonded to the thin film transistor array substrate to form the liquid crystal panel;

exposing the liquid crystal panel to light of a spectrum ranging from 300 nm to 450 nm and of an illuminance ranging from 10 mW/cm² to 30 mW/cm² when a wavelength of the light ranges from 300 nm to 400 nm, and exposing the liquid crystal panel for an exposure time period lasting for 30 to 50 seconds; and

curing the exposed liquid crystal panel and simultaneously applying a curing voltage to the liquid crystal panel.

Preferably, the illuminance of the light exposing the liquid crystal panel is 20 mW/cm² when the wavelength ranges from 300 nm to 400 nm.

Preferably, the curing voltage applied to the liquid crystal panel is a square wave voltage or a DC voltage, and an effective value of the curing voltage ranges from 10 volts to 20 volts.

Preferably, the effective value of the curing voltage applied to the liquid crystal panel is 15 volts.

Preferably, the manufacturing method further includes the following step simultaneously implemented with the step of curing the exposed liquid crystal panel: heating the exposed liquid crystal panel in a temperature ranging from 30 centigrade to 50 centigrade.

Preferably, the exposed liquid crystal panel is heated in the temperature of 40 centigrade.

Preferably, the manufacturing method further includes the following step before the step of exposing the liquid crystal panel: turning on an exposing light source and filtering the light emitted from the light source to obtain the light having spectrum ranging from 300 nm to 450 nm and having the illuminance ranging from 10 mW/cm² to 30 mW/cm² when the wavelength ranges from 300 nm to 400 nm.

Preferably, the light for exposing the liquid crystal panel has a main wavelength ranging from 340 nm to 350 nm, a full width at half maximum thereof ranges from 52 nm to 62 nm, and a full width at one-third maximum thereof ranges from 70 nm to 80 nm.

Preferably, the light for exposing the liquid crystal panel is emitted from an excimer light source, and excimer material of the light source is selected from the group consisting of KrF, ArP, NeF, and XeCl.

Another object of the present disclosure is to provide another manufacturing method of a liquid crystal panel. The manufacturing method includes the following steps:

adding polymer monomers into liquid crystals and injecting the liquid crystals into a space defined between a thin film transistor array substrate and a color filter substrate vacuum bonded to the thin film transistor array substrate;

exposing the liquid crystal panel to light of a spectrum ranging from 300 nm to 450 nm and an illuminance ranging from 5 mW/cm² to 15 mW/cm² when a wavelength of the light ranges from 300 nm to 400 nm, and exposing the liquid crystal panel for an exposure time period lasting for 40 to 60 seconds; and

curing the exposed liquid crystal panel and simultaneously applying a curing voltage to the liquid crystal panel.

Preferably, the illuminance of the light for exposing the liquid crystal panel is 10 mW/cm² when the wavelength ranges from 300 nm to 400 nm.

Preferably, the curing voltage applied to the liquid crystal panel is a square wave voltage or a DC voltage with an effective value thereof ranging from 10 volts to 20 volts.

Preferably, the effective value of the curing voltage is 15 volts.

Preferably, the manufacturing method as claimed in claim 12 further includes the following step simultaneously implemented with the step of curing the liquid crystal panel after the exposure process of the liquid crystal panel: heating the exposed liquid crystal panel in a temperature ranging from 30 centigrade to 50 centigrade.

Preferably, the temperature is 40 centigrade.

Preferably, the manufacturing method further includes the following step before the step of exposing the liquid crystal panel: turning on an exposing light source and filtering light emitted from the light source to obtain the light for exposing the liquid crystal panel having the spectrum ranging from 300 nm to 450 nm and the illuminance ranging from 5 mW/cm² to 15 mW/cm² when the wavelength of the light ranges from 300 nm to 400 nm.

Preferably, the light for exposing the liquid crystal panel has a main wavelength ranging from 315 nm to 325 nm, a full width at half maximum thereof ranges from 35 nm to 45 nm, and a full width at one-third maximum thereof ranges from 44 nm to 54 nm.

Preferably, the light for exposing the liquid crystal panel is emitted from an excimer light source, and excimer material of the light source is selected from the group consisting of KrF, ArP, NeF, and XeCl.

Manufactured by the above manufacturing method, the liquid crystal panel has an improved contrast and a higher liquid crystal response speed.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a flow chart of a manufacturing method of a liquid crystal panel in accordance with a first embodiment of the present disclosure;

FIG. 2 is a schematic view of a spectrum of light used in the manufacturing method of FIG. 1;

FIG. 3 is a schematic view showing the relationship between a contrast of the liquid crystal panel manufactured according to the manufacturing method of FIG. 1 and an exposure time period thereof;

FIG. 4 is a schematic view showing the relationship between the liquid crystal response time of the liquid crystal panel manufactured according to the manufacturing method of FIG. 1 and the exposure time period thereof;

FIG. 5 is a schematic view showing the relationship between the exposure time period of the liquid crystal panel manufactured according to the manufacturing method of FIG. 1 and a VT curved line;

FIG. 6 is a partially enlarged view of FIG. 5;

FIG. 7 is a schematic view showing the relationship between the exposure time period of the liquid crystal panel manufactured according to the manufacturing method of FIG. 1 and a voltage holding ratio (VHR);

FIG. 8 is a schematic view showing the relationship between the exposure time period of the liquid crystal panel manufactured according to the manufacturing method of FIG. 1 and a density of residual ions;

FIG. 9 is a flow chart of a manufacturing method of a liquid crystal panel in accordance with a second embodiment;

FIG. 10 is a schematic view of a spectrum of light used in the manufacturing method of FIG. 9;

FIG. 11 is a schematic view showing the relationship between a contrast of the liquid crystal panel manufactured according to the manufacturing method of FIG. 9 and the exposure time period thereof;

FIG. 12 is a schematic view showing the relationship between the liquid crystal response time of the liquid crystal panel manufactured according to the manufacturing method of FIG. 9 and the exposure time period thereof;

FIG. 13 is a schematic view showing the relationship between the exposure time period of the liquid crystal panel manufactured according to the manufacturing method of FIG. 9 and the VT curved line;

FIG. 14 is a partially enlarged view of FIG. 13;

FIG. 15 is a schematic view showing the relationship between the exposure time period of the liquid crystal panel manufactured according to the manufacturing method of FIG. 9 and the VHR;

FIG. 16 is a schematic view showing the relationship between the exposure time period of the liquid crystal panel manufactured according to the manufacturing method of FIG. 9 and the density of residual ions.

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

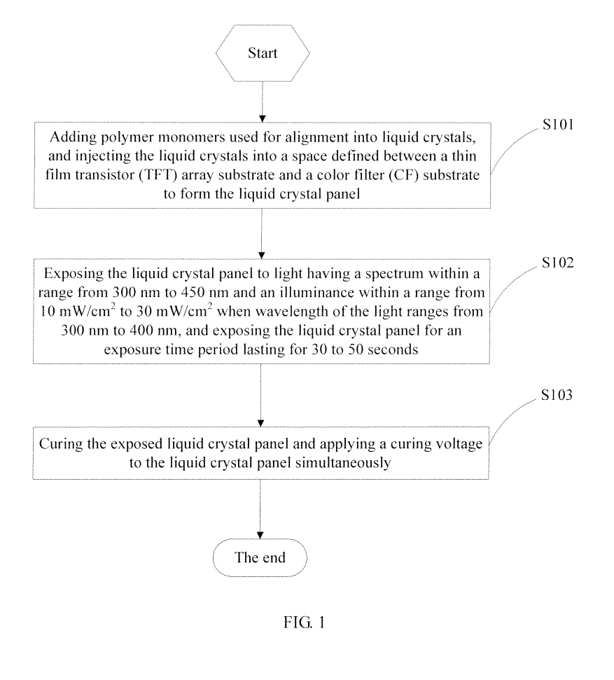

Referring to FIG. 1, a manufacturing method of a liquid crystal panel, in accordance with a first embodiment, is provided. The manufacturing method includes the following steps:

Step S101, adding polymer monomers used for alignment into liquid crystals, and injecting the liquid crystals into a space defined between a thin film transistor (TFT) array substrate and a color filter (CF) substrate to form the liquid crystal panel. After the polymer monomers are added into the liquid crystals, the polymer monomers can be irradiated by light to form a polymer layer which is capable of guiding liquid crystal molecules to be regularly arranged.

Step S102, exposing the liquid crystal panel to light having a spectrum within a range from 300 nm to 450 nm and an illuminance within a range from 10mW/cm² to 30 mW/cm² when wavelength of the light ranges from 300 nm to 400 nm, and exposing the liquid crystal panel for an exposure time period lasting for 30 to 50 seconds.

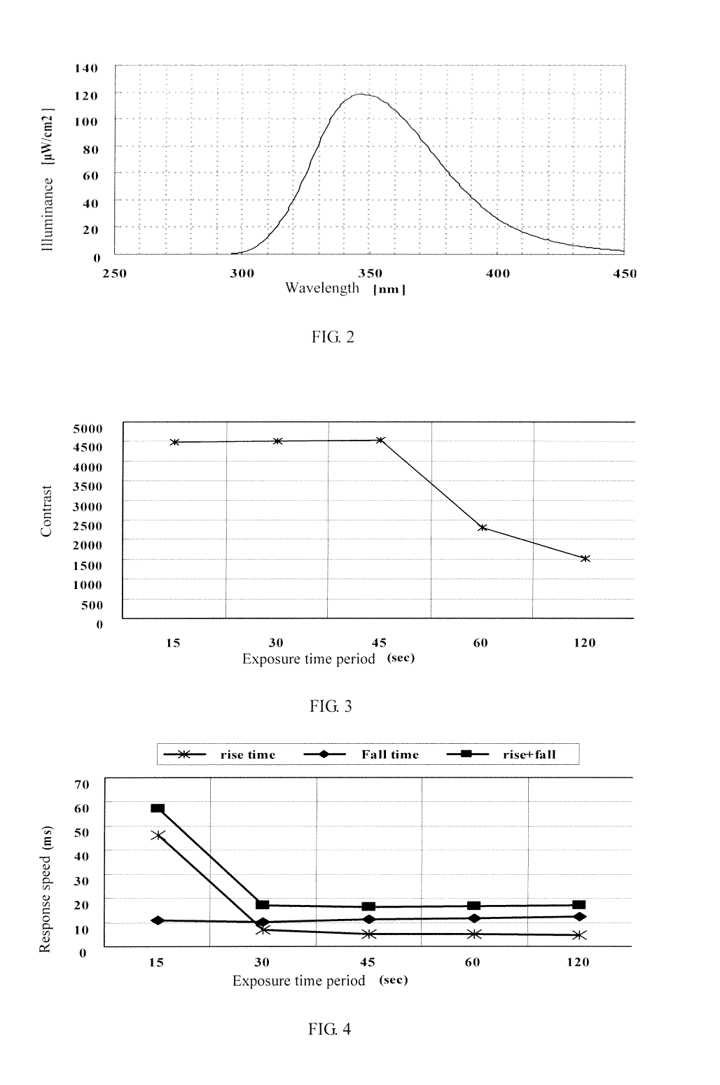

The liquid crystal molecules are guided to be regularly arranged by the polymer monomers when the liquid crystal panel is exposed. For example, a long axis of each liquid crystal molecules is perpendicular to the substrate of the liquid crystal panel, or is inclined relative to the substrate to form a tilt angle therebetween, or is parallel with the substrate. In the embodiment, the long axis of each liquid crystal molecules is perpendicular to the substrate of the liquid crystal panel. As shown in FIG. 2, the spectrum of light used in the manufacturing method of the liquid crystal panel is schematically shown. The light for exposing the liquid crystal panel has the spectrum ranging from 300 nm to 450 nm and the illuminance thereof ranges from 10 mW/cm² to 30 mW/cm² when the wavelength ranges from 300 nm to 400 nm. Preferably, the illuminance of the light is 20 mW/cm² when the wavelength of the light ranges from 300 nm to 400 nm.

Step S103, curing the exposed liquid crystal panel and applying a curing voltage to the liquid crystal panel simultaneously.

The liquid crystal panel includes the TFT array substrate, the CF substrate, and a liquid crystal layer sandwiched between the TFT array substrate and the CF substrate. The TFT array substrate is provided with a pixel electrode, and the CF substrate is provided with a common electrode. When the voltage is applied to the liquid crystal panel, a magnetic field is generated between the pixel electrode and the common electrode, which causes the liquid crystal molecules to respectively rotate over a predetermined angle. Therefore, the liquid crystal panel is cured after the liquid crystal molecules are respectively driven to rotate over the predetermined angle under the curing voltage. In this way, the liquid crystal molecules can rotate to appropriate positions quickly when a driving voltage is applied to the liquid crystal panel next time, which improves the response speed of the liquid crystal molecules. The curing voltage can be a square wave voltage or a DC voltage with an effective value thereof ranging from 10 volts to 20 volts. Preferably, the effective value of the curing voltage is 15 volts.

In the manufacturing method, the light used to expose the liquid crystal panel has the spectrum ranging from 300 nm to 450 nm and has the illuminance ranging from 10 mW/cm² to 30 mW/cm² when the wavelength ranges from 300 nm to 400 nm, which improves a contrast and a liquid crystal response speed of the liquid crystal panel.

Referring to FIG. 3, in which the relationship between the contrast and the exposure time period of the liquid crystal panel in the manufacturing method is schematically shown, and the longitudinal axis and the vertical axis thereof are respectively referred to the exposure time period and the contrast. As shown in FIG. 3, in the exposure time period (that is, the time period when the light keeps irradiating the liquid crystal panel) from 15 to 45 seconds, the contrast of the liquid crystal panel is almost unchanged. However, after the time point of 45 seconds, the contrast of the liquid crystal panel gradually reduces as the exposure time period goes on. Therefore, the liquid crystal panel is allowed to have an improved contrast when the exposure time period lasts for 15 to 45 seconds.

Referring to FIG. 4, in which the relationship between the liquid crystal response speed and the exposure time period of the liquid crystal panel manufactured according to the manufacturing method, is schematically shown, and the longitudinal axis and the vertical axis thereof are respectively referred to the exposure time period and the liquid crystal response speed. The liquid crystal response speed can be reflected according to the time required for the improving the brightness of the liquid crystal panel from 10% to 90% of the highest brightness level. The time required includes a rise time period and a fall time period. Since the brightness of the liquid crystal panel is proportional to the driving voltage applied thereto, thus, the change of the brightness is capable of reflecting the change of the driving voltage. As shown in FIG. 4, in the rise time period of the driving voltage, during the exposure time period from 15 to 30 seconds, the liquid crystal response time gradually become shorter as the exposure time period increases. That is, the longer the exposure time period is, the quicker the liquid crystal response speed of the liquid crystal panel is. The liquid crystal response speed remains unchanged when the exposure time period is over the time point of 30 seconds. In the fall time period, during the exposure time period from 15 to 120 seconds, the liquid crystal response speed also remains almost unchanged. Therefore, the liquid crystal panel is allowed to have an improved liquid crystal response speed with the exposure time period lasting for 30 to 120 seconds.

In this way, for allowing the liquid crystal panel to have an improved contrast and liquid crystal response speed, the liquid crystal panel can be exposed to light as shown in FIG. 2 with the exposure time period lasting for 30 to 50 seconds. Preferably, the exposure time period is 40 seconds.

After the exposure process, the liquid crystal panel can be placed on a platform to be cured. The curing temperature of the platform can range from 30 centigrade to 50 centigrade. Preferably, the curing temperature of the platform is 40 centigrade.

The main wavelength of the light used for exposing the liquid crystal panel ranges from 340 nm to 350 nm, a full width at half maximum of the light ranges from 52 nm to 62 nm, and a full width at one-third maximum of the light ranges from 70 nm to 80 nm. The full width at half maximum of the light is referred to the difference between two wavelength values corresponding to one half of the peak illuminance of the light, and the full width at one-third maximum of the light is referred to the difference between two wavelength values corresponding to one third of the peak illuminance of the light. The light can be emitted from an excimer light source which is capable of emitting ultraviolet light via excimer material. The excimer material can be selected from the group consisting of KrF, ArP, NeF, and XeCl. It is noted that in other embodiments, the light used for exposing the liquid crystal panel can also be emitted from other light sources. At this time, a filter can be disposed adjacent to the light source for filtering useless light in the exposure process of the liquid crystal panel.

Referring to FIGS. 5 and 6, in which FIG. 5 is a schematic view showing the relationship between the exposure time period of the liquid crystal panel manufactured according to the manufacturing method of FIG. 1 and a VT curved line, and FIG. 6 is a partially enlarged view of FIG. 5. The longitudinal axis of the VT curved line is referred to an effective value of the voltage, and the vertical axis thereof is referred to a transmittance of the liquid crystal panel. That is, the VT curved line shows the relationship between the voltage effective value and the transmittance. As shown in FIGS. 5 and 6, in the situation where the transmittance changes from 5% to 0% of the highest transmittance, the voltage of the liquid crystal panel when the exposure time period respectively lasts for 60 seconds and 120 seconds is relatively greater than the voltage of the liquid crystal panel when the exposure time period respectively lasts for 15 seconds, 30 seconds, and 45 seconds. Therefore, when the exposure time period respectively lasts for 15 seconds, 30 seconds, and 45 seconds, the liquid crystal panel is allowed to have more controlled gray scales.

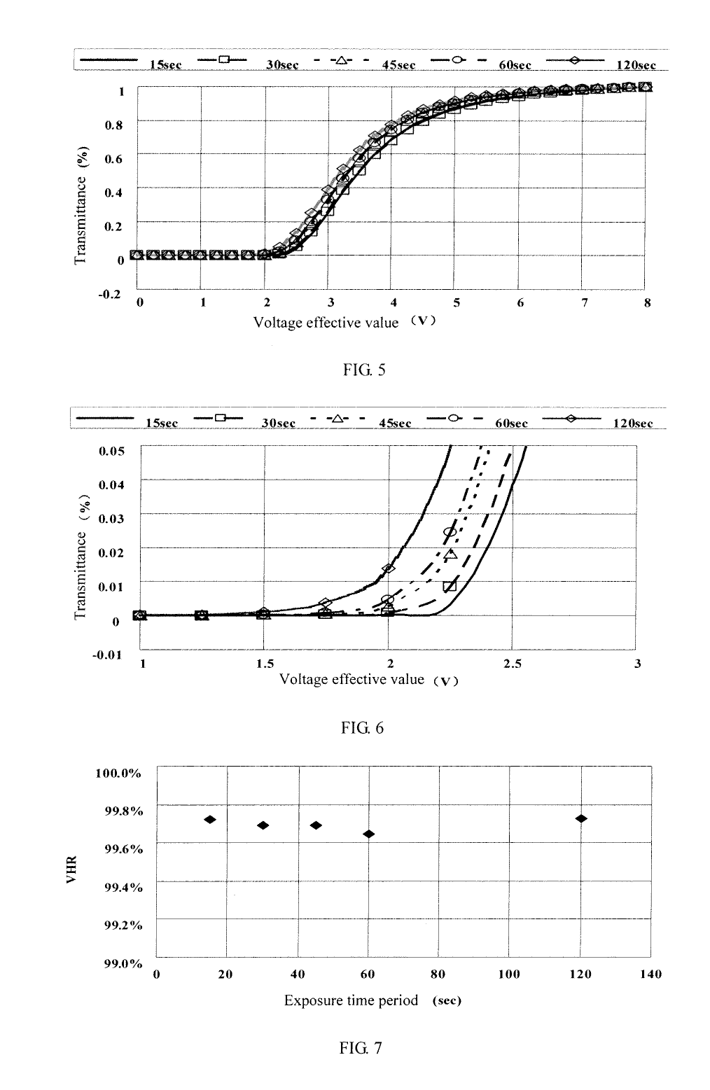

Referring to FIG. 7, in which the relationship between the exposure time period and a voltage holding ratio (VHR) is schematically shown. An experiment for detecting the VHR of the liquid crystal panel is carried out in the following conditions: temperature of 20±2 centigrade, voltage of ±5 volts, pulse width of 10 ms, period in which the voltage lasts of 166.7 ms. As shown in FIG. 7, the exposure time period does not influence the VHR of the liquid crystal panel.

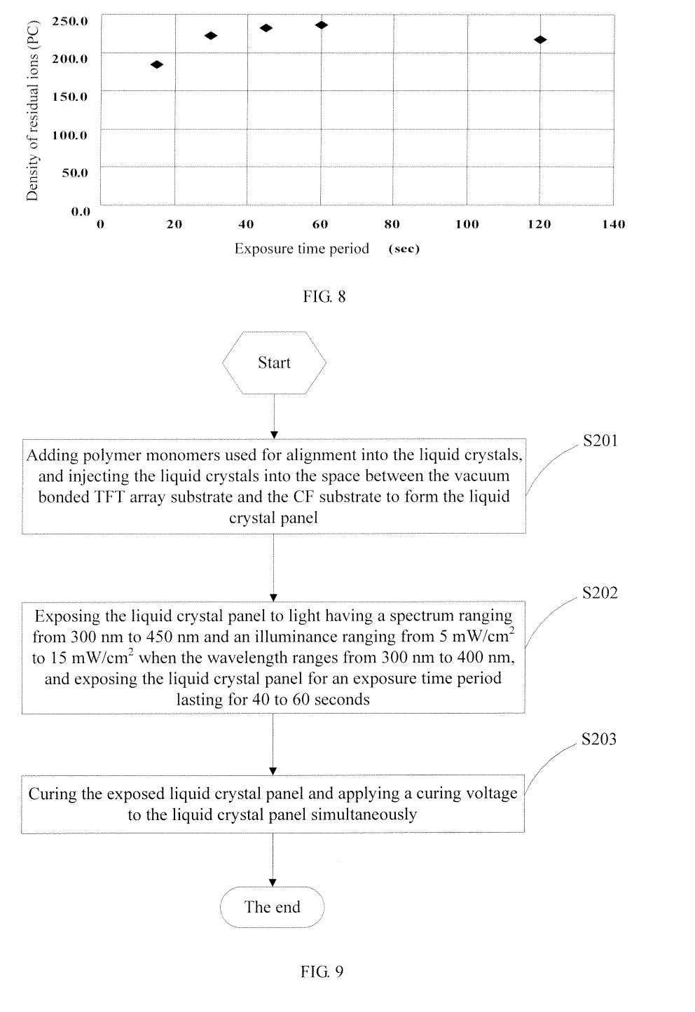

Referring to FIG. 8, in which the relationship between the exposure time period and a density of residual ions is schematically shown. After the exposure process of the liquid crystal panel, some impurities are produced due to the polymer monomers added into the liquid crystal molecules. Therefore, after the liquid crystal panel is manufactured, a test is carried out for detecting the density of the residual ions in the following conditions: temperature of 20±2 degrees Celsius, voltage of 5 volts, voltage of toothed wave, frequency of 0.01 Hz. As shown in FIG. 8, the density of the residual ions substantially remains unchanged as the exposure time period goes on.

Referring to FIG. 9, in which a manufacturing method of the liquid crystal panel, in accordance with a second embodiment is shown. The manufacturing method includes the following steps:

Step S201, adding polymer monomers used for alignment into the liquid crystals, and injecting the liquid crystals into the space between the vacuum bonded TFT array substrate and the CF substrate to form the liquid crystal panel.

Step S202, exposing the liquid crystal panel to light having a spectrum ranging from 300 nm to 450 nm and an illuminance ranging from 5 mW/cm² to 15 mW/cm² when the wavelength ranges from 300 nm to 400 nm, and exposing the liquid crystal panel for an exposure time period lasting for 40 to 60 seconds.

Step S203, curing the exposed liquid crystal panel and simultaneously applying a curing voltage to the liquid crystal panel.

The difference between the manufacturing method of the second embodiment and that of the first embodiment lies in that, in the manufacturing method of the second embodiment, the spectrum of the light for exposing the liquid crystal panel ranges from 300 nm to 400 nm and the illuminance thereof ranges from 5 mW/cm²to 15 mW/cm² when the wavelength ranges from 300 nm to 400 nm. As shown in FIG. 19, the spectrum of the light used in the manufacturing method of the second embodiment is schematically shown. The illuminance of the light is preferably 10 mW/cm² when the wavelength ranges from 300 nm to 400 nm, and the exposure time period lasts for 40 to 50 seconds. The exposure time period is preferably 50 seconds. The curing voltage applied to the liquid crystal panel can be a square wave voltage or a DC voltage and the effective value thereof can range from 10 volts to 20 volts. Preferably, the effective value is 15 volts.

In the manufacturing method, the spectrum of the light used to expose the liquid crystal panel ranges from 300 nm to 450 nm and the illuminance thereof ranges from 10 mW/cm² to 30 mW/cm² when the wavelength thereof ranges from 300 nm to 400 nm, which improves the contrast and the liquid crystal response time of the liquid crystal panel.

Referring to FIG. 11, in which the relationship between the contrast and the exposure time period of the liquid crystal panel in the manufacturing method of the second embodiment is schematically shown, and the longitudinal axis are respectively referred to the exposure time period and the contrast. As shown in FIG. 11, during the exposure time period from 15 to 60 seconds (that is, the period when the light keeps irradiating the liquid crystal panel), the contrast of the liquid crystal panel is almost unchanged (the contrast substantially keeps at 4500). However, after the time point of 60 seconds, the contrast of the liquid crystal panel gradually reduces as the exposure time period goes on. Therefore, the liquid crystal panel is allowed to have an improved contrast when the exposure time period lasts for 15 seconds to 60 seconds.

Referring to FIG. 12, in which the relationship between the liquid crystal response speed and the exposure time period of the liquid crystal panel manufactured according to the manufacturing method is schematically shown, and the longitudinal axis and the vertical axis thereof are respectively referred to the exposure time period and the liquid crystal response speed. The liquid crystal response speed can be reflected according to the time required for the improving the brightness of the liquid crystal panel from 10% to 90% of the highest brightness level. The time required includes a rise time period and a fall time period. Since the brightness of the liquid crystal panel is proportional to the driving voltage applied thereto, thus, the change of the brightness is capable of reflecting the change of the driving voltage. As shown in FIG. 12, in the rise time period of the driving voltage, the longer the exposure time period is, the quicker the liquid crystal response speed of the liquid crystal panel is; and in the fall time period, during the exposure time period from 30 to 45 seconds, the response speed of the liquid crystal gradually become higher as the exposure time period goes on and the liquid crystal response speed is kept almost unchanged after the time point of 45 seconds. Therefore, the liquid crystal panel is allowed to have an improved liquid crystal response speed with the exposure time period lasting for 45 to 120 seconds.

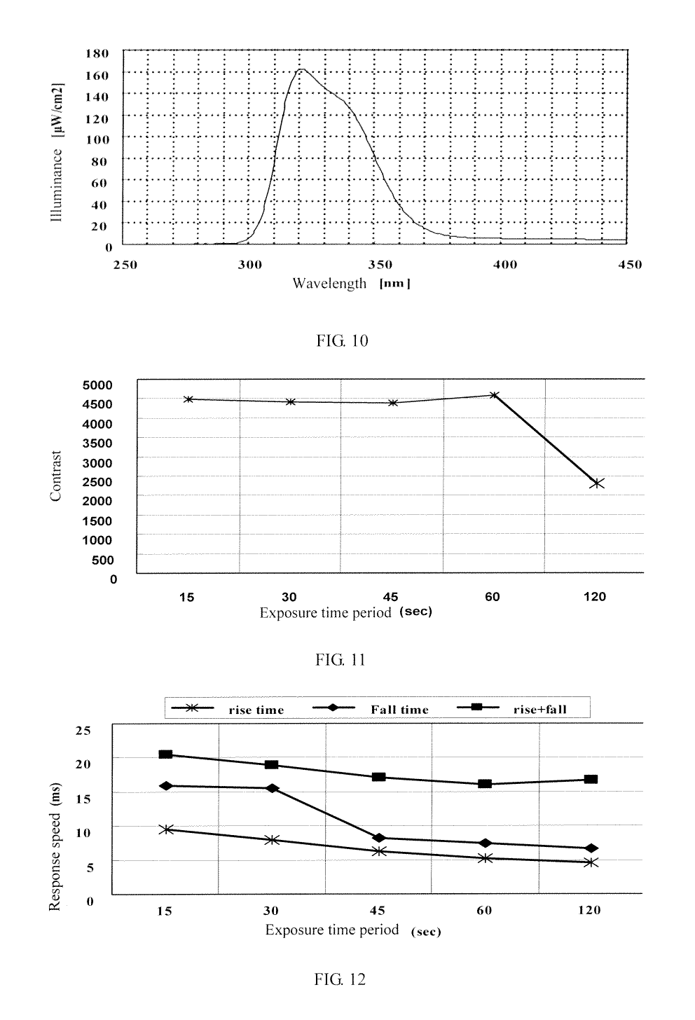

In this way, for allowing the liquid crystal panel to have an improved contrast and liquid crystal response speed, the liquid crystal panel can be exposed to light as shown in FIG. 10 with the exposure time period lasting for 40 to 60 seconds. Preferably, the exposure time period is 50 seconds.

After the exposure process, the liquid crystal panel can be placed on a platform to be cured. The curing temperature of the platform can range from 30 centigrade to 50 centigrade. Preferably, the curing temperature of the platform is 40 centigrade.

The main wavelength of the light used in the exposure ranges from 315 nm to 325 nm, a full width at half maximum of the light ranges from 35 nm to 45 nm, and a full width at one-third maximum of the light ranges from 44 nm to 54 nm. The full width at half maximum of the wavelength is referred to the difference between two wavelength values corresponding to one half of the peak illuminance of the light, and the full width at one-third maximum of the light is referred to the difference between two wavelength values corresponding to one third of the peak illuminance of the light. The light can be emitted from an excimer light source which is capable of emitting ultraviolet light via excimer material. The excimer material can be selected from the group consisting of KrF, ArP, NeF, and XeCl. It is noted that in other embodiments, the light used in the exposure can also be emitted from other light sources. At this time, a filter is disposed adjacent to the light source for filtering useless light in the exposure process of the liquid crystal panel.

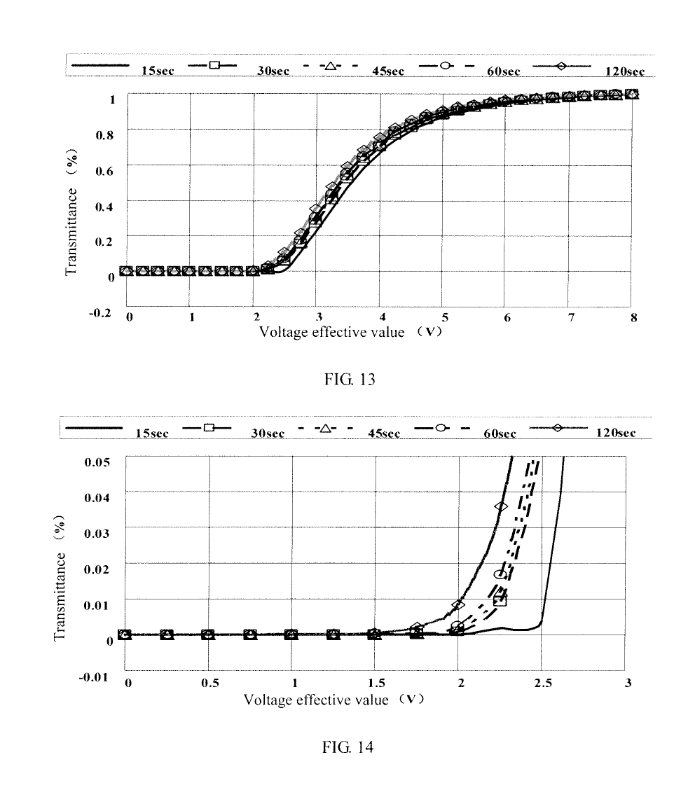

Referring to FIGS. 13 and 14, in which FIG. 13 is a schematic view showing the relationship between the exposure time period of the liquid crystal panel manufactured according to the manufacturing method of the second embodiment and a VT curved line, and FIG. 14 is a partially enlarged view of FIG. 13. The longitudinal axis of the VT curved line is referred to an effective value of the voltage, and the vertical axis thereof is referred to a transmittance of the liquid crystal panel. That is, the VT curved line shows the relationship between the voltage effective value and the transmittance. As shown in FIGS. 13 and 14, in the situation where the transmittance changes from 5% to 0% of the highest transmittance, the voltage of the liquid crystal panel when the exposure time period respectively lasts for 60 seconds and 120 seconds is relatively greater than the voltage of the liquid crystal panel when the exposure time period respectively lasts for 15 seconds, 30 seconds, 45 seconds, and 60 seconds, Therefore, when the exposure time period respectively lasts for 15 seconds, 30 seconds, 45 seconds, and 60 seconds, the liquid crystal panel is allowed to have more controlled gray scales.

Referring to FIG. 15, the relationship between the exposure time period and the VHR is schematically shown. The experiment for detecting the VHR of the liquid crystal panel is carried out in the following conditions: temperature of 20±2 centigrade, voltage of ±5 volts, pulse width of 10 ms, period in which the voltage lasts of 166.7 ms. As shown in FIG. 15, the exposure time period does not influence the VHR of the liquid crystal panel.

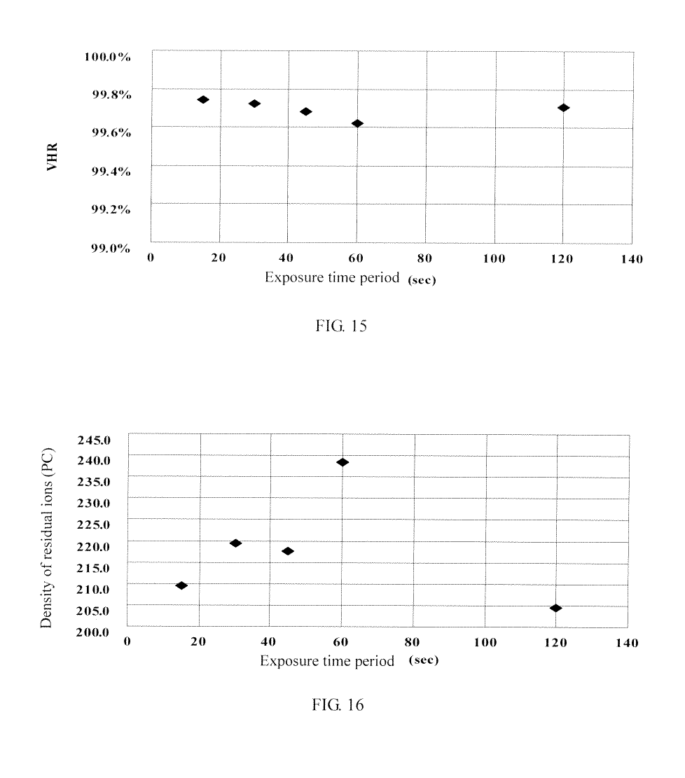

Referring to FIG. 16, the relationship between the exposure time period and the density of residual ions is schematically shown. After the exposure process of the liquid crystal panel, some impurities are produced due to the polymer monomer added into the liquid crystal molecules. Therefore, after the liquid crystal panel is manufactured, the test is carried out for detecting the density of the ions in the following conditions: temperature of 20±2 centigrade, voltage of 5 volts, voltage of toothed wave, frequency of 0.01 Hz. As shown in FIG. 16, the density of the residual ions substantially remains unchanged as the exposure time period goes on.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. A manufacturing method of a liquid crystal panel, comprising:
adding polymer monomers to liquid crystals and then injecting the liquid crystals into space between a thin film transistor array substrate and a color filter substrate vacuum bonded to the thin film transistor array substrate to form the liquid crystal panel;
exposing the liquid crystal panel to light of a spectrum ranging from 300 nm to 450 nm and of an illuminance ranging from 10 mW/cm² to 30 mW/cm² when the wavelength ranges from 300 nm to 400 nm, and exposing the liquid crystal panel for an exposure time period lasting for 30 to 50 seconds; and
curing the exposed liquid crystal panel and simultaneously applying a curing voltage to the liquid crystal panel.

2. The manufacturing method as claimed in claim 1, wherein the illuminance of the light exposing the liquid crystal panel is 20 mW/cm² when the wavelength ranges from 300 nm to 400 nm.

3. The manufacturing method as claimed in claim 1, wherein the curing voltage applied to the liquid crystal panel is a square wave voltage or a DC voltage, and an effective value of the curing voltage ranges from 10 volts to 20 volts.

4. The manufacturing method as claimed in claim 3, wherein the effective value of the curing voltage applied to the liquid crystal panel is 15 volts.

5. The manufacturing method as claimed in claim 3 further comprising the following step simultaneously implemented with the step of curing the exposed liquid crystal panel: heating the exposed liquid crystal panel in a temperature ranging from 30 centigrade to 50 centigrade.

6. The manufacturing method as claimed in claim 5, wherein the exposed liquid crystal panel is heated in the temperature of 40 centigrade.

7. The manufacturing method as claimed in claim 5 further comprising the following step before the step of exposing the liquid crystal panel:
turning on an exposing light source and filtering the light emitted from the light source to obtain the light having spectrum ranging from 300 nm to 450 nm and having the illuminance ranging from 10 mW/cm² to 30 mW/cm² when the wavelength ranges from 300 nm to 400 nm.

8. The manufacturing method as claimed in claim 1, wherein the light for exposing the liquid crystal panel has a main wavelength ranging from 340 nm to 350 nm, a full width at half maximum thereof ranges from 52 nm to 62 nm, and the full width at one-third maximum thereof ranges from 70 nm to 80 nm.

9. The manufacturing method as claimed in claim 1, wherein the light for exposing the liquid crystal panel is emitted from an excimer light source, and excimer material of the light source is selected from the group consisting of KrF, ArP, NeF, and XeCl.

10. A manufacturing method, comprising:
adding polymer monomers into liquid crystals and injecting the liquid crystals into a space defined between a thin film transistor array substrate and a color filter substrate vacuum bonded to the thin film transistor array substrate;
exposing the liquid crystal panel to light having a spectrum ranging from 300 nm to 450 nm and an illuminance ranging from 5 mW/cm² to 15 mW/cm² when a wavelength of the light ranges from 300 nm to 400 nm, and exposing the liquid crystal panel for an exposure time period lasting for 40 to 60 seconds; and
curing the exposed liquid crystal panel and simultaneously applying a curing voltage to the liquid crystal panel.

11. The manufacturing method as claimed in claim 11, wherein the illuminance of the light for exposing the liquid crystal panel is 10 mW/cm² when the wavelength of the light ranges from 300 nm to 400 nm.

12. The manufacturing method as claimed in claim 10, wherein the curing voltage applied to the liquid crystal panel is a square wave voltage or a DC voltage with an effective value thereof ranging from 10 volts to 20 volts.

13. The manufacturing method as claimed in claim 12, wherein the effective value of the curing voltage is 15 volts.

14. The manufacturing method as claimed in claim 12 further comprising the following step simultaneously implemented with the step of curing the exposed liquid crystal panel: heating the exposed liquid crystal panel in a temperature ranging from 30 centigrade to 50 centigrade.

15. The manufacturing method as claimed in claim 14, wherein the temperature is 40 centigrade.

16. The manufacturing method as claimed in claim 10 further comprising the following step before the step of exposing the liquid crystal panel:
turning on an exposing light source and filtering light emitted from the light source to obtain the light for exposing the liquid crystal panel having the spectrum ranging from 300 nm to 450 nm and the illuminance ranging from 5 mW/cm² to 15 mW/cm² when the wavelength of the light ranges from 300 nm to 400 nm.

17. The manufacturing method as claimed in claim 10, wherein the light for exposing the liquid crystal panel has a main wavelength ranging from 315 nm to 325 nm, a full width at half maximum thereof ranges from 35 nm to 45 nm, and a full width at one-third maximum thereof ranges from 44 nm to 54 nm.

18. The manufacturing method as claimed in claim 10, wherein the light for exposing the liquid crystal panel is emitted from an excimer light source, and excimer material of the light source is selected from the group consisting of KrF, ArP, NeF, and XeCl.
